(19) United States
(12) Patent Application Publication
(10) Pub. No.: US 2017/0064108 A1
(43) Pub. Date: Mar. 2, 2017

(54) LIGHT SCANNING APPARATUS AND IMAGE FORMING APPARATUS

(71) Applicant: CANON KABUSHIKI KAISHA, Tokyo (JP)

(72) Inventors: Toshiharu Mamiya, Yokohama-shi (JP); Hiroshi Nakahata, Abiko-shi (JP); Shinichiro Hosoi, Tokyo (JP); Yuta Okada, Moriya-shi (JP)

(21) Appl. No.: 15/244,948

(22) Filed: Aug. 23, 2016

(30) Foreign Application Priority Data
Sep. 1, 2015 (JP) 2015-172114

(51) Int. Cl. H04N 1/00; H04N 1/29; H04N 1/19; H04N 1/028

(52) U.S. Cl. CPC H04N 1/00525; H04N 1/02885; H04N 1/0283; H04N 1/29; H04N 1/19; H04N 2201/0091

(57) ABSTRACT

A light scanning apparatus, including: a first division unit configured to divide light emitted from a light source into a first and a second light beams; a deflection unit configured to deflect the first and second light beams to scan a first and a second scanned surfaces; a detection unit configured to detect the second light beam; a control unit configured to control, based on a detection result of the second light beam detected by the detection unit, a timing of the first light beam and a timing of the second light beam; and a second division unit configured to divide the first light beam into a third light beam and a fourth light beam and to guide the fourth light beam to the detection unit to control light intensity of the light source based on a detection result of the fourth light beam detected by the detection unit.

### BACKGROUND OF THE INVENTION

Field of the Invention

The present invention relates to a light scanning apparatus and an image forming apparatus, and more particularly, to a light scanning apparatus, which is used in a laser printer, a digital copying machine, and the like, and is configured to deflect laser light from a laser unit to form an image on a photosensitive member.

Description of the Related Art

With regard to image forming apparatus such as a laser beam printer or a digital copying machine, there has been well known a configuration of scanning a photosensitive drum by an exposure device, called a light scanning apparatus, to form a latent image on the photosensitive drum. In recent years, there has been a demand from a market for high-speed color print output of image forming apparatus, and hence there is generally employed a configuration called a tandem type including process units for respective colors (four colors of Y, M, C, and K) having photosensitive drums. As an example of the light scanning apparatus to be mounted in such image forming apparatus of the tandem type, there has been known a light scanning apparatus including two units each disposed in the image forming apparatus and configured to emit scanning lights of two routes from one unit to scan photosensitive drums for two colors among Y, M, C, and K. Such a light scanning apparatus is called a 2-in-1 type. A light scanning apparatus having a configuration of emitting a scanning light of one route from one unit is called a 1-in-1 type.

In the light scanning apparatus of the 2-in-1 type, a light beam emitted from a light source is deflected by rotation of a rotary polygon mirror and formed into an image on a scanned surface by an fθ lens to perform constant speed scanning, to thereby form a latent image on the scanned surface. In such an optical system, two scanning optical paths including a first scanning optical path and a second optical path are disposed symmetrically over the rotary polygon mirror (see FIG. 1 described later). For downsizing of the light scanning apparatus, the light beams, which travel along the respective scanning optical paths, are turned back by reflecting mirrors.

Further, there has been known a method for increasing the number of beams from a light source to achieve higher speed and higher image quality. In recent years, a vertical cavity surface emitting laser (VCSEL) (hereinafter referred to as surface emitting laser) is used to dramatically increase the number of beams. However, in view of expensiveness of the surface emitting laser and needs for downsizing, resource conservation, and the like, there has been a demand for reduction of the number of light source units. As a method for reducing the number of the light source units, there has been proposed, for example, a configuration of the 2-in-1 type. In the 2-in-1 type configuration, a light source unit is shared by preventing scanning timings of a first scanning optical path and a second scanning optical path from overlapping with each other (Japanese Patent Application Laid-Open No. 2012-194333). The light scanning apparatus of such a type is hereinafter referred to as a division type.

When the surface emitting laser is used, it is necessary, in view of device characteristics, to have a configuration of extracting a part of laser light emitted from a light emission point, detecting light intensity, and feeding back the light intensity (hereinafter referred to as F-APC) in order to perform highly accurate light intensity control. However, in the light scanning apparatus of the division type described above, there is a problem in that an incident optical system becomes more complex to cause an increase in the size of the light scanning apparatus.

### SUMMARY OF THE INVENTION

The present invention has been made under such circumstances, and an object of the present invention is to achieve light intensity control for a light source while saving space in a light scanning apparatus of a division type.

According to an embodiment of the present invention, there is provided a light scanning apparatus, comprising:

a light source;

a first division unit configured to divide light emitted from the light source into a first light beam and a second light beam;

a deflection unit configured to reflect the first light beam to scan a first scanned surface and to reflect the second light beam to scan a second scanned surface;

a detection unit configured to detect the second light beam reflected by the deflection unit;

a control unit configured to control, based on a result of detection of the second light beam detected by the detection unit, a timing of scanning the first scanned surface with the first light beam and a timing of scanning the second scanned surface with the second light beam; and

a second division unit disposed between the first division unit and the deflection unit and configured to divide the first light beam into a third light beam and a fourth light beam, the second division unit being configured to guide the fourth light beam to the detection unit so as to allow the control unit to control light intensity of the light emitted from the light source based on a result of detection of the fourth light beam detected by the detection unit.

According to another embodiment of the present invention, there is provided an image forming apparatus, comprising:

a first image bearing member;

a second image bearing member;

a light source;

a first division unit configured to divide light emitted from the light source into a first light beam and a second light beam;

a deflection unit configured to reflect the first light beam to scan a surface of the first image bearing member so as to form a latent image, and to reflect the second light beam to scan a surface of the second image bearing member so as to form a latent image;

a detection unit configured to detect the second light beam reflected by the deflection unit;

a control unit configured to control, based on a result of detection of the second light beam detected by the detection unit, a timing of scanning the surface of the first image bearing member with the first light beam and a timing of scanning the surface of the second image bearing member with the second light beam; and

a second division unit disposed between the first division unit and the deflection unit and configured to divide the first light beam into a third light beam and a fourth light beam, the second division unit being configured to guide the fourth light beam to the detection unit so as to allow the control unit to control light intensity of the light emitted from the light source based on a result of detection of the fourth light beam detected by the detection unit.

Further features of the present invention will become apparent from the following description of exemplary embodiments with reference to the attached drawings.

### BRIEF DESCRIPTION OF THE DRAWINGS

FIG. 1 is a sectional view for illustrating a configuration of a light scanning apparatus of a 2-in-1 type according to an embodiment.

FIG. 2 is a schematic sectional view of an image forming apparatus according to the embodiment.

FIG. 3 is a block diagram for illustrating a control system for the image forming apparatus according to the embodiment.

FIG. 4 is a developed view of the light scanning apparatus according to the embodiment.

FIG. 5A is an enlarged view of a light source unit according to the embodiment.

FIG. 5B is an enlarged view of a VCSEL serving as a light source.

FIG. 6A is a diagram for illustrating a relationship between scanning faces and rotation angles of a rotary polygon mirror according to the embodiment.

FIG. 6B is a diagram for illustrating light emission timings.

### DESCRIPTION OF THE EMBODIMENTS

Now, an embodiment of the present invention will be described in detail with reference to the drawings.

[Light Scanning Apparatus and Image Forming Apparatus]

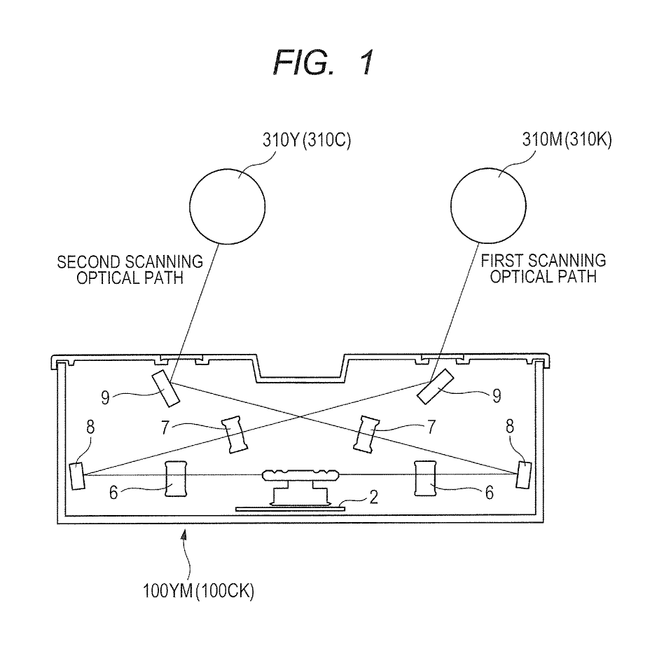

FIG. 1 is a sectional view for illustrating a configuration of a light scanning apparatus according to the embodiment. A light scanning apparatus 100YM illustrated in FIG. 1 is a unit configured to emit scanning lights of two routes, and such a type is hereinafter referred to as a 2-in-1 type. As illustrated in FIG. 1, a light beam emitted from a light source is scanned by rotation of a rotary polygon mirror 2 serving as a deflection unit and is formed into an image on a scanned surface by fθ lenses 6 and 7 to perform constant speed scanning, to thereby form a latent image on the scanned surface. In the optical system, two scanning optical paths including a first scanning optical path and a second scanning optical path are disposed symmetrically across the rotary polygon mirror 2. A light beam travelling along the first scanning optical path is scanned on a surface (image bearing member surface) of a photosensitive drum 310M serving as the scanned surface, and a light beam travelling along the second scanning optical path is scanned on a surface of a photosensitive drum 310Y serving as the scanned surface. For downsizing of the light scanning apparatus 100YM, the light beams which travel along the respective scanning optical paths are turned back by reflecting mirrors 8 and 9. As described later, the image forming apparatus according to the embodiment includes the light scanning apparatus 100YM and a light scanning apparatus 100CK. A configuration of the light scanning apparatus 100CK is the same as that of the light scanning apparatus 100YM, and hence description thereof is omitted.

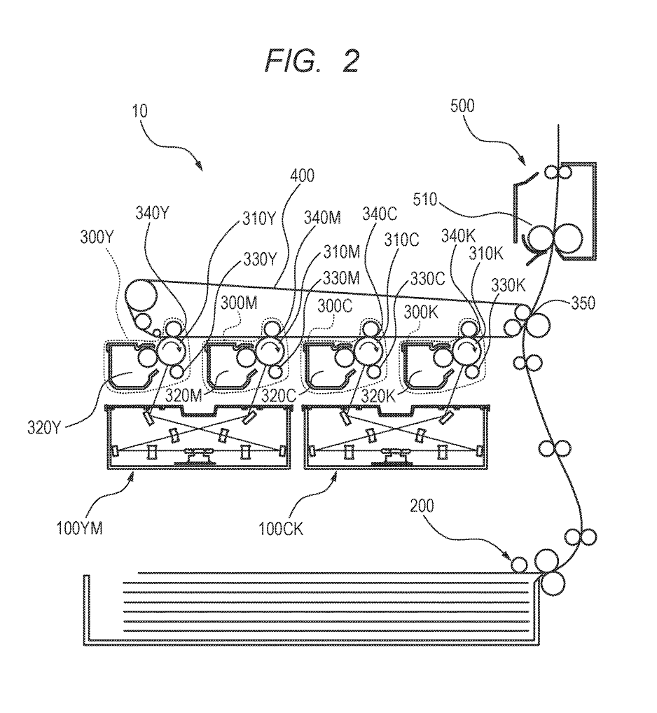

FIG. 2 is a sectional view for illustrating one example of an image forming apparatus 10, and only relevant parts associated with an image forming operation are illustrated. The image forming apparatus 10 includes a sheet feeding portion 200, process units 300Y, 300M, 300C, and 300K, the light scanning apparatus 100YM and 100CK, an intermediate transfer belt 400, and a fixing portion 500. The sheet feeding portion 200 is configured to feed a sheet serving as a recording medium to a conveyance passage. The process units 300Y, 300M, 300C, and 300K are configured to form toner images. The light scanning apparatus 100YM is configured to scan photosensitive drums 310Y and 310M in the process units 300Y and 300M to form latent images thereon. The light scanning apparatus 100CK is configured to scan photosensitive drums 310C and 310K in the process units 300C and 300K to form latent images thereon. Toner images on the process units 300Y, 300M, 300C, and 300K for four colors are superimposed one after another on the intermediate transfer belt 400, and the toner images of four colors formed on the intermediate transfer belt 400 are collectively transferred onto the sheet. The fixing portion 500 is configured to fix the unfixed toner images transferred onto the sheet.

The process units 300Y, 300M, 300C, and 300K are disposed for four colors including Y (yellow), M (magenta), C (cyan), and K (black). The process unit 300Y includes the photosensitive drum 310Y, a developing portion 320Y, and a charging portion 330Y. After the charging portion 330Y charges the photosensitive drum 310Y, the light scanning apparatus 100YM exposes the photosensitive drum 310Y with light to form a latent image, and the developing portion 320Y causes toner to adhere to the latent image on the photosensitive drum 310Y to develop the latent image into a visible image. This similarly applies to the process unit 300M, and hence description thereof is omitted. Further, this similarly applies also to the process units 300C and 300K except for the fact that latent images are formed by the light scanning apparatus 100CK, and hence description thereof is omitted. Yet further, the suffixes Y, M, C, and K of the reference symbols are omitted unless otherwise required.

As illustrated in FIG. 2, the image forming apparatus 10 according to the embodiment has a configuration in which the light scanning apparatus 100YM and the light scanning apparatus 100CK are disposed as two units each configured to emit scanning lights of two routes. The light scanning apparatus 100YM is configured to scan the photosensitive drum 310Y for Y and the photosensitive drum 310M for M. The light scanning apparatus 100CK is configured to scan the photosensitive drum 310C for C and the photosensitive drum 310K for K.

The toner images of the respective colors are superimposed one after another on the intermediate transfer belt 400 at first transfer portions 340 at which the photosensitive drums 310 are in contact with the intermediate transfer belt 400, and then collectively transferred at a second transfer portion 350 onto a sheet having been conveyed from the sheet feeding portion 200. The sheet having the toner images of four colors transferred thereon is conveyed to the fixing portion 500, and nipped by fixing rollers 510 to receive heat and pressure so that the toner images are fixed on the sheet.

[Configuration for Controlling Image Forming Apparatus]

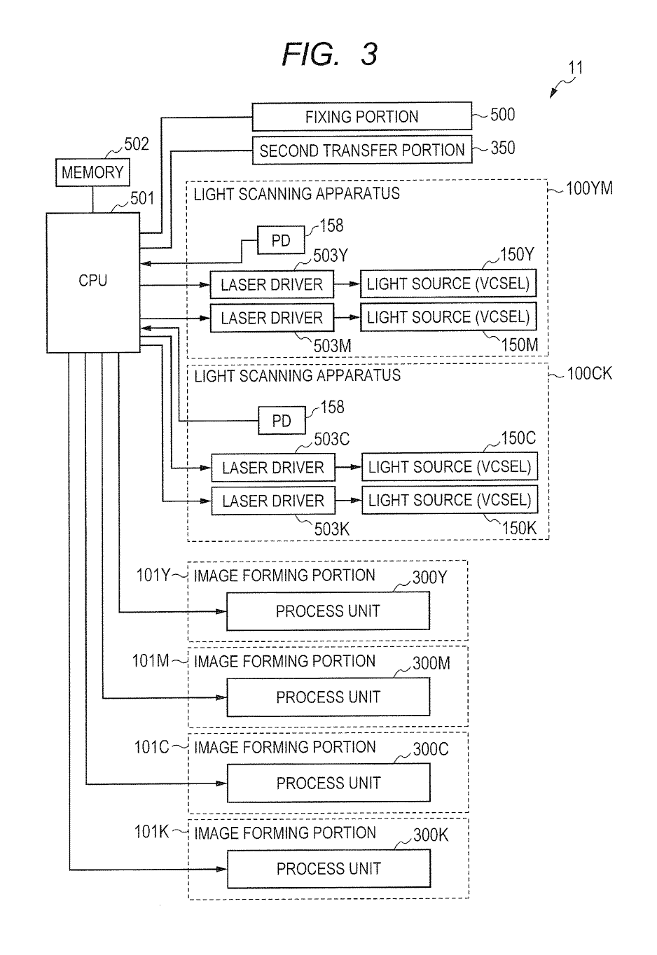

FIG. 3 is a block diagram for illustrating a control system 11 for the image forming apparatus 10 according to the embodiment. Components of image forming portions for respective colors according to the embodiment are the same, and hence an image forming portion 101Y will hereinafter be described. Description of image forming portions 101M, 101C, and 101K is omitted. A CPU 501 is a controller (control unit) configured to cause each element to execute predetermined control based on a control program stored in a memory 502. The process units 300 illustrated in FIG. 3 each comprehensively represent a drive unit (not shown) configured to drive the photosensitive drum 310, the charging portion 330, the developing portion 320, the first transfer portion 340, and a drum cleaning portion (not shown), and detailed description of control therefor is omitted. Further, the CPU 501 is configured to control the second transfer portion 350 and the fixing portion 500 configured to fix toner images on a sheet, but detailed description of the control is omitted.

The memory 502 is configured to store, in addition to the control program, reference value data to be used at the time of executing automatic power control (hereinafter referred to as APC), timing data defining emission timings of each light emitting element, and the like. The CPU 501 includes a clock signal generating portion, e.g., a crystal oscillator, configured to generate a clock signal having a frequency higher than that of a synchronization signal, and a counter configured to count the clock signal.

The CPU 501 is configured to receive a synchronization signal output from a photodiode (hereinafter referred to as “PD”) 158, which is a detection unit configured to be scanned with a second light beam L2 described later to detect the second light beam L2. Further, the CPU 501 is configured to receive a detection signal output from the PD 158 having detected a fourth light beam L4 described later. The CPU 501 is configured to output a control signal to a laser driver 503 based on the synchronization signal received from the PD 158, and the laser driver 503 is configured to transmit a drive signal to a light source 150 based on the received control signal. More specifically, for example, a laser driver 503Y is configured to transmit a drive signal to a light source 150Y based on a received control signal, and a laser driver 503M is configured to transmit a drive signal to a light source 150M based on a received control signal. Herein, as described above, the light sources 150Y and 150M are vertical cavity surface emitting lasers (VCSEL). The light scanning apparatus 100CK also has the same configuration as the above-mentioned light scanning apparatus 100YM, and hence description thereof is omitted.

[Light Scanning Apparatus]

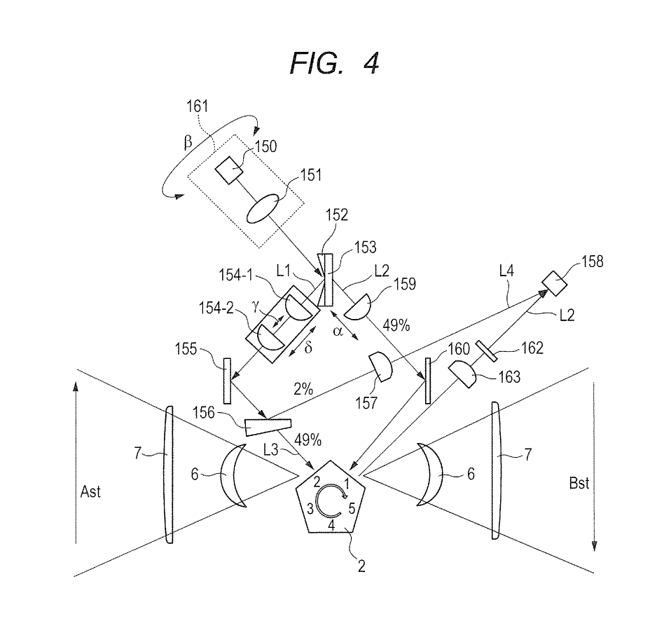

Next, the light scanning apparatus 100 will be described in detail. FIG. 4 is a developed view for illustrating a state in which the reflecting mirrors 8 and 9 are excluded from arrangement of components in the light scanning apparatus 100 and in which the intersected scanning optical paths as can be seen in FIG. 1 are developed so as not to intersect, and is a view as viewed from above the light scanning apparatus 100. A direction of scanning a scanned surface (that is, on a surface of the photosensitive drum 310) with a light beam is hereinafter referred to as a main scanning direction, and a direction orthogonal to both the main scanning direction and an optical axis direction is hereinafter referred to as a sub-scanning direction. In the developed view of FIG. 4, a direction of a rotation axis of the rotary polygon mirror 2 is the sub-scanning direction. Meanwhile, in a state in which optical paths are turned back by the reflecting mirrors 8 and 9 as illustrated in FIG. 1, the sub-scanning direction is also inclined with respect to the direction of the rotation axis of the rotary polygon mirror 2 in accordance with respective optical axis directions of the fθ lenses 6 and 7. An optical path extending from the light source 150 to the rotary polygon mirror 2 is referred to as an incident optical path, and an optical path extending from the rotary polygon mirror 2 to the scanned surface is referred to as an emission optical path. Further, the emission optical path on the left side in FIG. 4 is referred to as a first scanning optical path (Ast), and the emission optical path on the right side in FIG. 4 is referred to as a second scanning optical path (Bst). The fθ lenses 6 and 7 which are disposed on the first scanning optical path are the same as those disposed on the second scanning optical path, respectively. Yet further, in reality, the scanning optical paths are turned back by the reflecting mirrors 8 and 9 as illustrated in FIG. 1 and accommodated in a housing of the light scanning apparatus 100.

In the following, the incident optical path will be described in detail. A light beam emitted from the light source 150 passes through a collimator lens 151 to be transformed into collimated light. The light source 150 and the collimator lens 151 are formed into a unit, and are hereinafter referred to as a light source unit 161. The light beam formed into the collimated light by the collimator lens 151 passes through an aperture 152 and thereafter is divided into two light beams by a first half mirror 153 (hereinafter simply referred to as half mirror 153) serving as a first division unit. The light beam reflected by the half mirror 153 is hereinafter referred to as a first light beam L1, and the light beam having passed through the half mirror 153 is hereinafter referred to as a second light beam L2.

The second light beam L2 having passed through the half mirror 153 passes through a cylinder lens 159 and a reflecting mirror 160 and then enters the rotary polygon mirror 2. The rotary polygon mirror 2 is rotated in a direction of the arrow of FIG. 4 and has five reflection faces in the embodiment (see FIG. 4), but the number of the reflection faces is not limited to five. The second light beam L2 deflected by the rotary polygon mirror 2 is formed into an image on the scanned surface (surface of the photosensitive drum 310) by the fθ lenses 6 and 7 to perform scanning at constant speed, to thereby form a latent image on the photosensitive drum 310. The first light beam L1 reflected by the half mirror 153 passes through a first cylinder lens 154-1, a second cylinder lens 154-2, and a reflecting mirror 155 to reach a second half mirror 156 (hereinafter simply referred to as half mirror 156) serving as a second division unit. The first cylinder lens 154-1 is hereinafter simply referred to as a cylinder lens 154-1, and the second cylinder lens 154-2 is simply referred to as a cylinder lens 154-2. The first light beam L1 having reached the half mirror 156 is divided into a third light beam L3 and a fourth light beam L4 by the half mirror 156.

Herein, of the first light beam L1 having reached the half mirror 156, a light beam having passed through the half mirror 156 is referred to as the third light beam L3, and a light beam having been reflected by the half mirror 156, passed through an APC lens 157, and been guided to the PD 158 is referred to as the fourth light beam L4. The APC lens 157 is a lens configured to form the fourth light beam L4 into an image at a predetermined light spot on the PD 158. The PD 158, e.g., a photodiode, is a sensor configured to output a voltage in accordance with light intensity of light entering a light receiving surface. A part (fourth light beam L4) of the light beam on the incident optical path is extracted by the half mirror 156, the APC lens 157, and the PD 158, to thereby detect the light intensity. The configuration of feeding back to the emitted light intensity of the light source 150 based on a result of detection of the fourth light beam L4 by the PD 158 as described above is hereinafter referred to as a front monitor auto power control (F-APC) configuration. The PD 158 of the embodiment can also be used for the F-APC, and hence the PD 158 also functions as an APC sensor. Further, after having passed through the half mirror 156, the third light beam L3 is deflected by the rotary polygon mirror 2 and formed into an image on the scanned surface (surface of the photosensitive drum 310) by the fθ lenses 6 and 7 to perform scanning at constant speed, with the result that a latent image is formed on the photosensitive drum 310.

In the embodiment, the aperture 152 is disposed upstream of the division of the incident optical path, and the light beam diameters of the first light beam L1 and the second light beam L2 become substantially equal. Thus, the optical efficiencies on the optical path of the first light beam L1 and on the optical path of the second light beam L2 are substantially equal. Thus, it is only necessary that the F-APC using the PD 158 is performed on any one of incident optical paths of the first light beam L1 and the second light beam L2, and that the F-APC mechanism is disposed at one location.

On a side (a scanning starting side in the main scanning direction) upstream of a region (hereinafter referred to as image forming region) on the second scanning optical path where image data is output, a BD lens 163 is disposed (on an incident side) upstream of the PD 158 for synchronization detection. Herein, the synchronization detection is used to allow the CPU 501 to determine a timing of starting scanning in the main scanning direction based on a result of detection of the second light beam L2 by the PD 158. As illustrated in FIG. 4, a light intensity ratio of the second light beam L2, the third light beam L3, and the fourth light beam L4 divided by the two half mirrors 153 and 156 is set to be 49:49:2. Therefore, at the time of performing the synchronization detection, a light beam (second light beam L2 (49%)) having light intensity higher than that of a light beam (fourth light beam L4 (2%)) entering the PD 158 at the time of performing the F-APC operation enters the PD 158. In view of the above, for the purpose of optimizing the performance of the sensor, a natural density filter (ND filter) 162 serving as a reduction unit is disposed on the incident side of the PD 158, to thereby adjust the light intensity of the light beam entering the PD 158. The same effect can be obtained with use of an adjustment unit configured to adjust sensitivity by electrically switching the sensitivity of the PD 158 without use of the ND filter 162.

[Adjustment of Interval and Light Spot Diameter in Sub-Scanning Direction]

Next, adjustment of an interval of optical paths in the sub-scanning direction and a light spot diameter in the sub-scanning direction will be described. When the scanned surface is scanned with a plurality of laser light beams, it is necessary to adjust an interval of the light beams in the sub-scanning direction. In the light scanning apparatus 100 of the 2-in-1 type as in the embodiment, there is unevenness in the optical elements on the emission optical path, and hence it is necessary to adjust intervals of the emission optical paths in the sub-scanning direction, respectively.

(Adjustment of Second Light Beam L2)

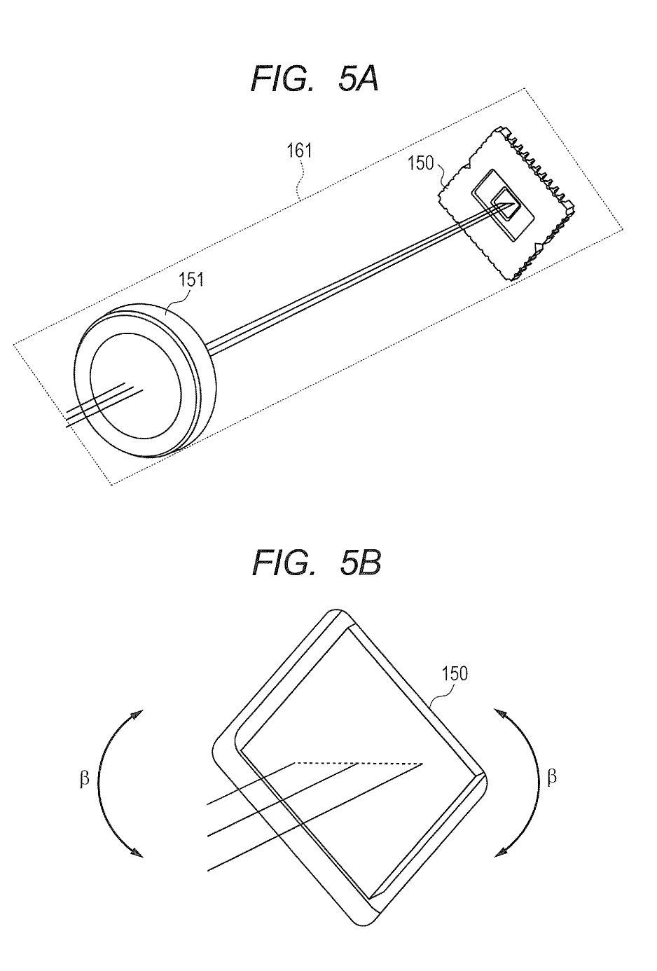

As to the second light beam L2, a light spot diameter in the sub-scanning direction is adjusted by adjusting a position of the cylinder lens 159 disposed on an emission side of the half mirror 153 in an optical axis direction (the arrow α in FIG. 4). A light spot diameter is detected at a position of the scanned surface when the cylinder lens 159 is displaced in the optical axis direction, and the cylinder lens 159 is fixed at a position where a minimum light spot diameter is obtained. After the cylinder lens 159 in the optical axis direction is adjusted, the light source unit 161 is rotated about the optical axis (the arrow (in FIG. 4), to thereby adjust the interval in the sub-scanning direction. Herein, FIG. 5A is an enlarged view for illustrating main portions of the light source unit 161. FIG. 5B is an enlarged view of the VCSEL serving as the light source 150. As illustrated in FIG. 5A and FIG. 5B, in the light source 150 of the embodiment, a plurality of light emitting elements indicated by the black points in FIG. 5B are arranged in array with one line. Therefore, the intervals of light beams in the sub-scanning direction can be changed by rotating the light source unit 161. The intervals in the sub-scanning direction can be adjusted in a similar way even when the light emitting elements of the light source 150 are arranged in two-dimensional array with two lines.

(Adjustment of Third Light Beam L3)

As to the third light beam L3 (first light beam), an interval in the sub-scanning direction and a light spot diameter are adjusted with the cylinder lens 154-1 and the cylinder lens 154-2. The interval (arrow γ) between the cylinder lens 154-1 and the cylinder lens 154-2 is adjusted to change magnification as in a zoom lens, to thereby adjust the interval in the sub-scanning direction on the scanned surface. Further, the two cylinder lenses 154-1 and 154-2 are displaced in the optical axis direction (the arrow δ) while maintaining the constant interval therebetween, to thereby adjust the light spot diameter in the sub-scanning direction on the scanned surface. Specifically, the light spot diameter of the light beam at a position of the scanned surface when the cylinder lens 154-1 and the cylinder lens 154-2 are displaced in the optical axis direction while maintaining the constant interval therebetween is detected, and the cylinder lenses 154-1 and 154-2 are fixed at the position where a minimum light spot diameter is obtained.

For the purpose of securing an optical path of the light beam (fourth light beam L4) entering the PD 158 in order to perform the APC, in the embodiment, the half mirror 156 is disposed on the optical path of the first light beam L1, and hence the fourth light beam L4 is guided to the PD 158 in a form of intersecting with the optical path of the second light beam L2. Further, in the embodiment, over the rotary polygon mirror 2, the light source unit 161 is disposed on the first scanning optical path side (Ast) in FIG. 4, and the PD 158 is disposed on the second scanning optical path side (Bst) in FIG. 4. In other words, the PD 158 is provided on a side opposite to the light source unit 161 with respect to an axis which is parallel to the main scanning direction and passes through a rotation axis of the rotary polygon mirror 2. With this, the PD 158 is disposed on a side opposed to the light source unit 161, and hence the APC can be performed without increasing the size of the light scanning apparatus 100. Further, the optical path of the second light beam L2 has less number of cylinder lenses than the optical path of the first light beam L1, that is, only the cylindrical lens 159 is disposed on the optical path of the second light beam L2, and hence the optical elements and the optical paths can be easily disposed. It may also be configured such that two cylinder lenses 159 are disposed on the optical path of the second light beam L2 as in the case of arranging the two cylinder lenses 154-1 and 154-2.

[As to Division Type]

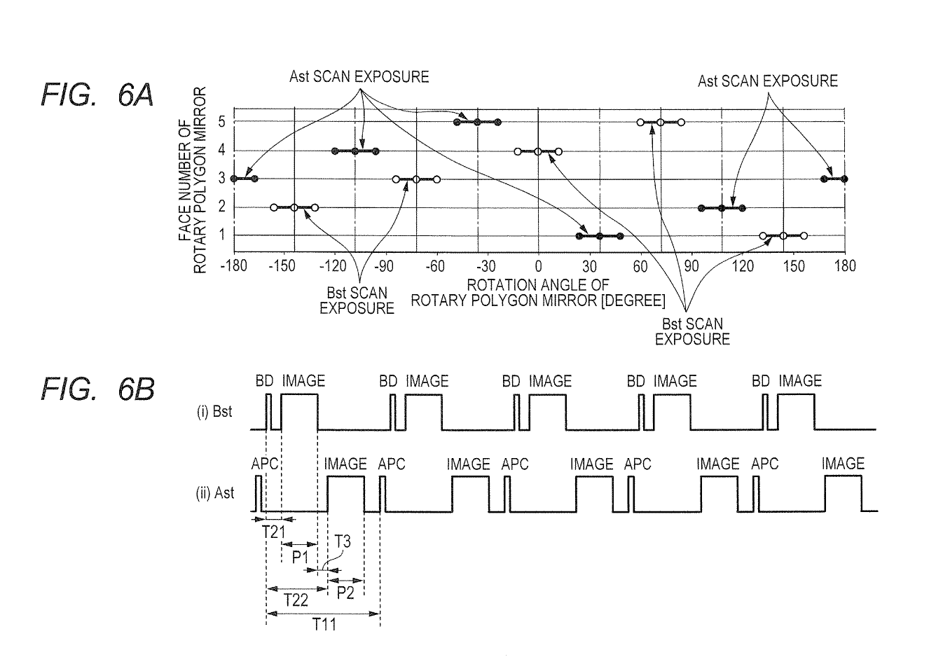

Next, a sequence of the division type will be described with reference to FIG. 6A and FIG. 6B. The light scanning apparatus 100 of the 2-in-1 type in the embodiment is of the division type in which the light source unit 161 is shared by causing scanning timings of the first scanning optical path and the second scanning optical path to be prevented from overlapping with each other. Two different scanning optical paths are scanned with light emitted from one light source unit 161, and hence it is necessary that timings of scanning the scanned surface with light on the first scanning optical path and light on the second scanning optical path be completely separated. Herein, a scanned surface to be scanned with light on the first scanning optical path is referred to as a first scanned surface, and a scanned surface to be scanned with light on the second scanning optical path is referred to as a second scanned surface.

In the graph of FIG. 6A, the horizontal axis represents rotation angles (degrees) of the rotary polygon mirror 2, and the vertical axis represents numbers (face numbers) of reflection faces (also referred to as scanning faces) of the rotary polygon mirror 2. In FIG. 6A, the first scanned surface is scanned at the timings with rotation angles plotted with the black circles (Ast scan exposure), and the second scanned surface is scanned at the timings with rotation angles plotted with the white circles (Bst scan exposure). The light source unit 161 is shared, and hence when the first scanned surface is scanned, reflected light from the rotary polygon mirror 2 is also reflected to the second scanning optical path. However, the reflected light reflected to the second scanning optical path by the rotary polygon mirror 2 is reflected toward a region other than the second scanned surface, and hence there is no influence on image formation. This similarly applies to the reflected light to be reflected to the first scanning optical path by the rotary polygon mirror 2 when the second scanned surface is scanned.

FIG. 6B is a timing chart per one scanning on each scanned surface, illustrating one rotation (for five scanning faces) of the rotary polygon mirror 2. More specifically, (i) in FIG. 6B represents timings of the Bst scan exposure, and (ii) in FIG. 6B represents timings of the Ast scan exposure. The horizontal axis of FIG. 6B represents a time. In FIG. 6B, a timing at which the second light beam L2 is input to the PD 158 for synchronization detection is denoted by “BD”, and a timing at which the fourth light beam L4 is input to the PD 158 for the F-APC is denoted by “APC”. Further, in FIG. 6B, a timing at which a light beam based on image data is radiated on the image forming region of the first scanning optical path (Ast) and a timing at which a light beam based on image data is radiated on the image forming region of the second scanning optical path (Bst) are denoted by “IMAGE”.

The light intensity detection needs to be performed in the region other than the image formation, that is, at a timing at which the signal denoted by “IMAGE” of 6B is not output. In the embodiment, the image formation is performed on the second scanned surface during a period P1 after elapse of a time T21 from output of the synchronization signal (BD) of the PD 158, more specifically, with a rising edge of the synchronization signal as a reference. Further, the image formation is performed on the first scanned surface during a period P2 after elapse of a time T22 from output of the synchronization signal of the PD 158. In the embodiment, the light intensity detection is performed at a timing of elapse of a time T11 from output of the synchronization signal of the PD 158.

As described above, the light beam diameters on the first scanning optical path and the second scanning optical path are substantially equal, and hence it is only necessary that the light intensity detection be performed during one scanning on each scanned surface. Further, the light intensity detection may be performed at a timing before start of the image formation or after termination of the image formation, or may be performed during a time period (T3) from the termination of scanning on the second scanned surface to the start of scanning on the first scanned surface. Further, a difference in the light intensity may occur between the first optical path and the second optical path due to unevenness in the light beam partially extracted by the half mirror 156 for the F-APC and in the optical elements on the emission optical paths. As to the difference in the light intensity which may occur, the light intensity on each optical path may be measured in advance during an assembling step, and the light intensity may be changed based on the measured value corresponding to an optical path to be scanned, thereby being capable of performing highly fine image formation.

The reflecting mirrors 8 and 9 are disposed on the first scanning optical path and the second scanning optical path, respectively, to turn back the optical paths, with the result that the light scanning apparatus 100 is downsized (see FIG. 1). With the influence of unevenness in the reflection films of the reflecting mirrors 8 and 9, unevenness in molding of the lenses, and reflection angles of the rotary polygon mirror 2, even when the light source 150 emits light at a constant light intensity, there is a case where the light intensity varies depending on positions on the scanned surface in the main scanning direction. In such a case, the light intensity may be measured in advance at some positions in the main scanning direction, and a light intensity profile may be created to make corrections so as to obtain a constant light intensity on a scanned surface in accordance with reflection angles of the rotary polygon mirror 2, thereby being capable of improving evenness in the density. This profile may be measured for each scanning optical path, and the profile can also be switched at a timing of switching the scanned surface, thereby being capable of reducing the density difference. Further, a light beam for the light intensity detection can be guided to a space having less optical elements, and hence the light intensity detection unit can be disposed with good layout property and without complication of the optical paths due to addition of a mirror.

As described above, according to the embodiment, the light intensity control for a light source can be achieved while saving space in the light scanning apparatus of the division type.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-172114, filed Sep. 1, 2015, which is hereby incorporated by reference herein in its entirety.

What is claimed is:

1. A light scanning apparatus, comprising:
a light source;
a first division unit configured to divide light emitted from the light source into a first light beam and a second light beam;
a deflection unit configured to reflect the first light beam to scan a first scanned surface and to reflect the second light beam to scan a second scanned surface;
a detection unit configured to detect the second light beam reflected by the deflection unit;
a control unit configured to control, based on a result of detection of the second light beam detected by the detection unit, a timing of scanning the first scanned surface with the first light beam and a timing of scanning the second scanned surface with the second light beam; and
a second division unit disposed between the first division unit and the deflection unit and configured to divide the first light beam into a third light beam and a fourth light beam, the second division unit being configured to guide the fourth light beam to the detection unit so as to allow the control unit to control light intensity of the light emitted from the light source based on a result of detection of the fourth light beam detected by the detection unit.

2. A light scanning apparatus according to claim 1, wherein the light scanning apparatus has an aperture disposed between the light source and the first division unit.

3. A light scanning apparatus according to claim 1, wherein the second division unit comprises a half mirror.

4. A light scanning apparatus according to claim 1, wherein light intensity of the fourth light beam is lower than light intensity of the second light beam.

5. A light scanning apparatus according to claim 4, further comprising a reduction unit disposed between the second light beam and the detection unit and configured to reduce light intensity of the second light beam.

6. A light scanning apparatus according to claim 5, wherein the reduction unit comprises an ND filter.

7. A light scanning apparatus according to claim 5, wherein the reduction unit comprises an adjustment unit configured to adjust sensitivity of the detection unit.

8. A light scanning apparatus according to claim 1, wherein the deflection unit is configured to reflect the third light beam to scan the first scanned surface.

9. A light scanning apparatus according to claim 8, further comprising:
a mirror configured to guide the second light beam to the second scanned surface; and
a mirror configured to guide the third light beam to the first scanned surface.

10. A light scanning apparatus according to claim 1, wherein the control unit is configured to control the light intensity by detecting the fourth light beam by the detection unit before start of scanning on the first scanned surface by the third light beam.

11. A light scanning apparatus according to claim 1, wherein the control unit is configured to control the light intensity by detecting the fourth light beam by the detection unit during a period from termination of scanning on the first scanned surface by the third light beam to start of scanning on the second scanned surface by the second light beam.

12. A light scanning apparatus according to claim 1, wherein the control unit is configured to control the light intensity by detecting the fourth light beam by the detection unit after termination of scanning on the second scanned surface by the second light beam.

13. A light scanning apparatus according to claim 1, wherein the light source comprises a surface emitting laser.

14. A light scanning apparatus according to claim 1, wherein the detection unit is disposed on a side opposite to the light source with respect to an axis which is parallel to a main scanning direction and passes through a rotation axis of the deflection unit.

15. An image forming apparatus, comprising:
a first image bearing member;
a second image bearing member;
a light source;
a first division unit configured to divide light emitted from the light source into a first light beam and a second light beam;
a deflection unit configured to reflect the first light beam to scan a surface of the first image bearing member so as to form a latent image, and to reflect the second light beam to scan a surface of the second image bearing member so as to form a latent image;
a detection unit configured to detect the second light beam reflected by the deflection unit;
a control unit configured to control, based on a result of detection of the second light beam detected by the detection unit, a timing of scanning the surface of the first image bearing member with the first light beam and a timing of scanning the surface of the second image bearing member with the second light beam; and
a second division unit disposed between the first division unit and the deflection unit and configured to divide the first light beam into a third light beam and a fourth light beam, the second division unit being configured to guide the fourth light beam to the detection unit so as to allow the control unit to control light intensity of the light emitted from the light source based on a result of detection of the fourth light beam detected by the detection unit.
